(19) United States
(12) Patent Application Publication
(10) Pub. No.: US 2010/0206782 A1
(43) Pub. Date: Aug. 19, 2010

(54) CONE LIP ASSEMBLY

(75) Inventors: Richard C. Britting, Gastonia, NC (US); Marko Makinen, Tampere (FI); George W. Schlemmer, Blythewood, SC (US); James Michael Anderson, Toccoa, GA (US); David Brian Cody, Elgin, SC (US); D. Leon Luadzers, Columbia, SC (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: METSO MINERALS INDUSTRIES, INC., Waukesha, WI (US)

(21) Appl. No.: 12/372,189

(22) Filed: Feb. 17, 2009

(51) Int. Cl. B07B 13/04; B07B 1/28

(52) U.S. Cl. 209/682; 209/314; 209/320

(57) ABSTRACT

A cone lip assembly for use in directing particulate material from a vibrating screen unit to a cone crusher includes separate mounting brackets to facilitate the attachment and detachment of the cone lip assembly from the vibrating screen unit. The cone lip assembly includes a main body defined by a pair of side plates that transition from an infeed end to a discharge end. The cone lip assembly includes a pair of mounting brackets that allow secure attachment and detachment of the entire cone lip assembly from the vibrating screen unit. The mounting brackets are formed separate from the main body of the cone lip assembly.

### BACKGROUND

The present disclosure generally relates to screening devices used to classify particulate material and feed the classified particulate material to a cone crusher. More specifically, the present disclosure relates to a cone lip assembly that is received on a vibrating screen unit and directs the classified particulate material to a cone crusher.

A vibrating screen unit is a device that accomplishes the separation of a source of particulate feed material into various size classes. This classification is accomplished by feeding the material to be classified to the vibrating screen unit, which is vibrating in a controlled reciprocating manner in a vertical plane. The particulate material fed onto the vibrating screen unit is repeatedly jostled by the vibrating screen unit such that the finer particulate material passes through at least one deck having a screening surface containing apertures for passage of small, undersized particles. The larger, oversized particles remain on the upper deck of the vibrating screen unit. In many vibrating screens, a middle deck is utilized to further screen particles of reduced size. A bottom deck receives particles of the smallest size which can then be directed to an outfeed conveyor for further handling.

The particulate material remaining on the top deck, and possibly the middle deck, may be large rocks or stones such as extracted during mining operations. These relatively large stones or rocks are fed to the infeed bowl of a cone crusher. The cone crusher operates to crush the particulate material from the vibrating screen unit to reduce the size of the particulate matter. The combination of the vibrating screen and the cone crusher are used in many different mining operations to reduce the size of the mined material to a desirable constituent size.

In many current applications, the supply of material from the vibrating screen unit is received on a cone lip that provides the required transition from the vibrating screen unit to the cone crusher. Most of the currently available cone lips include angled side plates that direct the flow of particulate to a discharged lip positioned above the bowl of the cone crusher. Since the cone lip receives a significant volume and weight of material to be crushed, the cone lip is of a significant size and weight, which restricts the ability to remove the cone lip from the vibrating screen unit when desired.

### SUMMARY

The present disclosure relates to a cone lip assembly for directing a supply of particulate material from a vibrating screen unit to a crusher. The cone lip assembly is selectively attachable and detachable from the vibrating screen unit to facilitate the reconfiguration of the feed assembly supplying material to the cone crusher.

The cone lip assembly includes a main body and a pair of mounting plates. The combination of the main body and mounting plates can be used to securely attach the cone lip assembly to the vibrating screen unit.

The main body of the cone lip assembly includes a pair of spaced side plates that each converge toward each other from a first end. Each side plate includes a second end such that the second ends of the side plate define a discharge of the cone lip assembly.

The main body of the cone lip assembly includes an upper base wall and a lower base wall that each extend between the pair of spaced side plates. The upper base wall is configured to receive material from the top deck of the vibrating screen unit while the lower base wall is configured to receive the particulate material from the middle screen deck of the vibrating screen unit. The particulate material received on the upper and lower base wall combine together within the cone lip assembly such that the combined supply of particulate matter exits the cone lip assembly at the discharge end.

The mounting brackets of the cone lip assembly each are selectively attachable to one of the side plates of the main body through a series of connectors and fasteners. The series of connectors and fasteners securely hold the mounting brackets in place along the side plates. However, the fasteners and connectors allow the mounting brackets to be selectively detached from the main body of the cone lip assembly.

Each of the mounting brackets includes a screen mounting section having a series of mounting holes that are configured to align with a corresponding series of mounting holes within the sidewalls of the vibrating screen unit. Another series of connectors attach the mounting brackets to the first and second sidewalls of the vibrating screen unit.

When it is desired to remove the cone lip assembly from the vibrating screen unit, the series of connectors attaching the mounting brackets to the side walls of the vibrating screen unit are removed and the cone lip assembly can be detached from the vibrating screen unit. The cone lip assembly preferably includes a pair of lifting eyes that allow a lifting assembly to remove the cone lip assembly from the vibrating screen unit.

Alternatively, the series of connectors and fasteners holding the mounting brackets to the side plates of the cone lip assembly main body can be removed and the main body of the cone lip assembly can then be separated from the mounting brackets that remain attached to the vibrating screen unit. In either manner, the cone lip assembly is attachable to the vibrating screen unit through the pair of mounting brackets that are formed separate from the main body of the cone lip assembly.

### BRIEF DESCRIPTION OF THE DRAWINGS

The drawings illustrate the best mode presently contemplated of carrying out the invention. In the drawings:

FIG. 1 is a front perspective view showing the cone lip assembly mounted to one end of a vibrating screen unit;

FIG. 2 is a perspective view illustrating the detachment of the cone lip assembly from the vibrating screen unit;

FIG. 3 is a side view of the cone lip assembly attached to the vibrating screen unit;

FIG. 3a is a magnified view taken along line 3a-3a of FIG. 3;

FIG. 4 is a perspective view of the cone lip assembly showing one of the mounting plates removed from the main body of the cone lip assembly; and

FIG. 5 is a front view of the cone lip assembly.

### DETAILED DESCRIPTION OF THE DRAWINGS

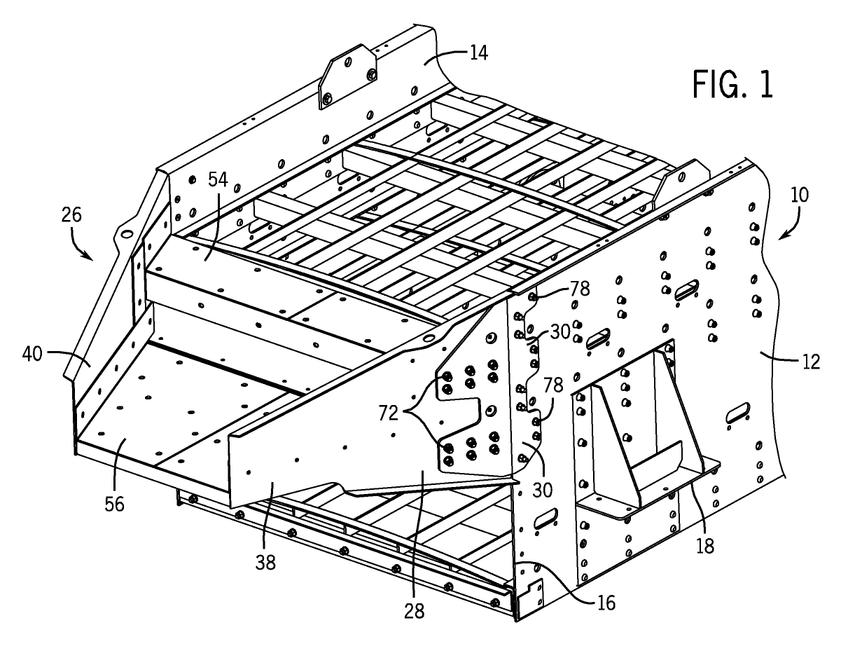

FIG. 1 illustrates a vibrating screen unit 10 for use with the present disclosure. The vibrating screen unit 10 includes a first sidewall 12 and a second sidewall 14 that is disposed in a spaced, parallel orientation. The vibrating screen unit 10 extends from an infeed end (not shown) to an outfeed end 16. The vibrating screen unit includes a series of mounting flanges 18 that each receive coiled compression springs (not shown) to provide the vibrating movement of the vibrating screen unit 10 in a known, conventional manner. In the embodiment shown in FIG. 1, the vibrating screen unit 10 is a flat series, horizontal screen, Model No. FS303 sold by Metso Minerals Industries. However, various other vibrating screen units 10 are contemplated as being within the scope of the present disclosure.

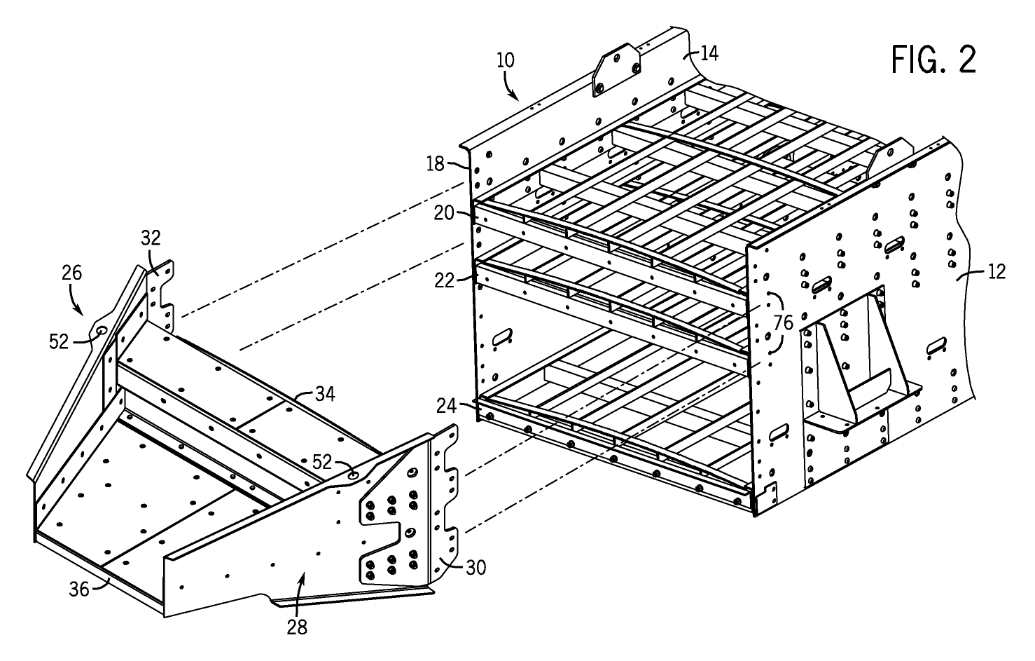

FIG. 2 provides an illustration of the outfeed end 16 of the vibrating screen unit 10. As illustrated in FIG. 2, the vibrating screen unit 10 includes a top screen deck 20, a middle screen deck 22 and a bottom screen deck 24. The top screen deck 20 has a relatively coarser mesh screen fabric (not shown) having relatively large apertures that allow particles smaller than a first size to pass through the top screen deck 20. Particles that pass through the top screen deck 20 are then received by the middle screen deck 22, which has smaller apertures to let particles having a slightly smaller size to pass through to the bottom deck 24. The particulate material that is received on the bottom deck 24 is typically of the desired size for the crushing operation and represents particulate materials of a desired size.

In typical mining operations, the supply of particulate material that remains on the top screen deck 20 and the middle screen deck 22 includes particulate material larger than a determined acceptable size. The particulate material from the top screen deck 20 and the middle screen deck 22 is directed to a crushing device, such as a cone crusher, for reducing the size of the particulate material. As an example, the vibrating screen unit 10 can be utilized to feed particulate material to a cone crusher, such as the HP303 cone crusher available from Metso Minerals Industries, although other crushing devices are contemplated as being within the scope of the present disclosure. The cone crusher typically includes a bowl that receives the supply of particulate material from the vibrating screen unit and operates to reduce the size of the particulate material in a crushing operation. The operation and design of the cone crusher does not form part of the present disclosure and thus is not shown in the drawings of the present application.

Referring back to FIG. 1, a cone lip assembly 26 is shown mounted to the discharge end 16 of the vibrating screen unit 10. As described above, the supply of particulate material from the vibrating screen unit 10 can be fed to a cone crusher for reducing the particulate size. The cone lip assembly 26 is mounted to the discharge end 16 of the vibrating screen unit 10 to direct the particulate material to the infeed bowl of a cone crusher. In the embodiment shown in FIGS. 1 and 2, the cone lip assembly 26 receives the particulate material from both the top screen deck 20 and the middle screen deck 22. The cone lip assembly 26 combines the flow of particulate material from the top deck 20 and the middle deck 22 to direct the combined material flow to the cone crusher.

As illustrated in FIG. 2, the cone lip assembly 26 includes a main body 28 and a pair of mounting brackets 30 and 32. As illustrated in FIG. 1, the mounting brackets 30 and 32 allow the main body 28 to be securely mounted to the discharge end 16 of the vibrating screen unit 10.

Referring back to FIG. 2, the main body 28 of the cone lip assembly 26 extends from an infeed end 34 to a discharge end 36. The infeed end 34 receives the supply of particulate material from the vibrating screen unit 10 and the configuration of the main body 28 directs the particulate material to the discharge end 36.

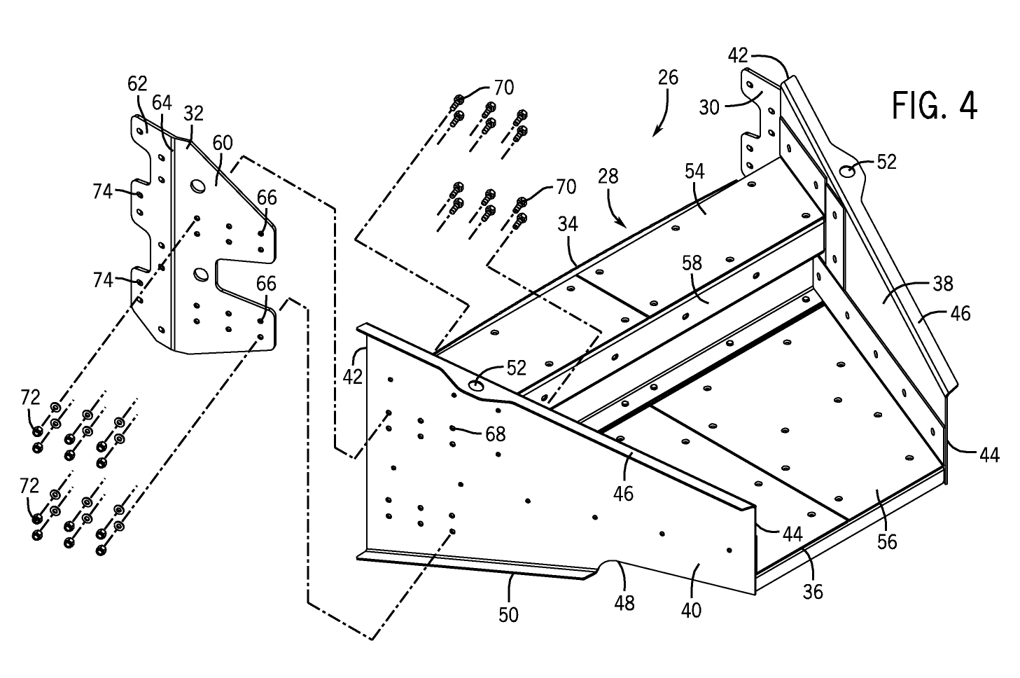

As best shown in FIG. 4, the main body of the cone lip assembly 26 includes a pair of spaced side plates 38, 40 that each extend from a first end 42 to a second end 44. Each of the side plates 38, 40 includes a top lip 46 that is angled perpendicular to the generally planar side plates 38, 40. In the embodiment shown in FIG. 4, the bottom edge 48 of each of the side plates 38, 40 angles upward from the first end 42 to the second end 44. The bottom edge 48 includes a flange 50 that extends generally perpendicular to the generally planar side plates 38, 40. In the embodiment illustrated in FIG. 4, the top lip 46 of each side plate 38, 40 includes a lifting eye 52 that provides a point of attachment for lifting equipment to aid in mounting the cone lip assembly 26 to the vibrating screen unit. The size and location of the lifting eyes 52 is selected to provide sufficient strength for the cone lip assembly 26 such that the cone lip assembly 26 can be lifted by appropriate equipment.

As described previously, the cone lip assembly 26 is configured to receive particulate material from both the top screen deck 20 and the middle screen deck 22. As illustrated in FIG. 2, the top screen deck 20 and the middle screen deck 22 are vertically offset from each other. To accommodate this type of vibrating screen unit 10, the cone lip assembly 26 shown in FIG. 4 includes both an upper base wall 54 and a lower base wall 56. The upper base wall 54 and the lower base wall 56 extend between and are each securely attached to an inner surface of the pair of side plates 38, 40. Preferably, the upper base wall 54 and the lower base wall 56 are formed from durable material, such as a sheet metal.

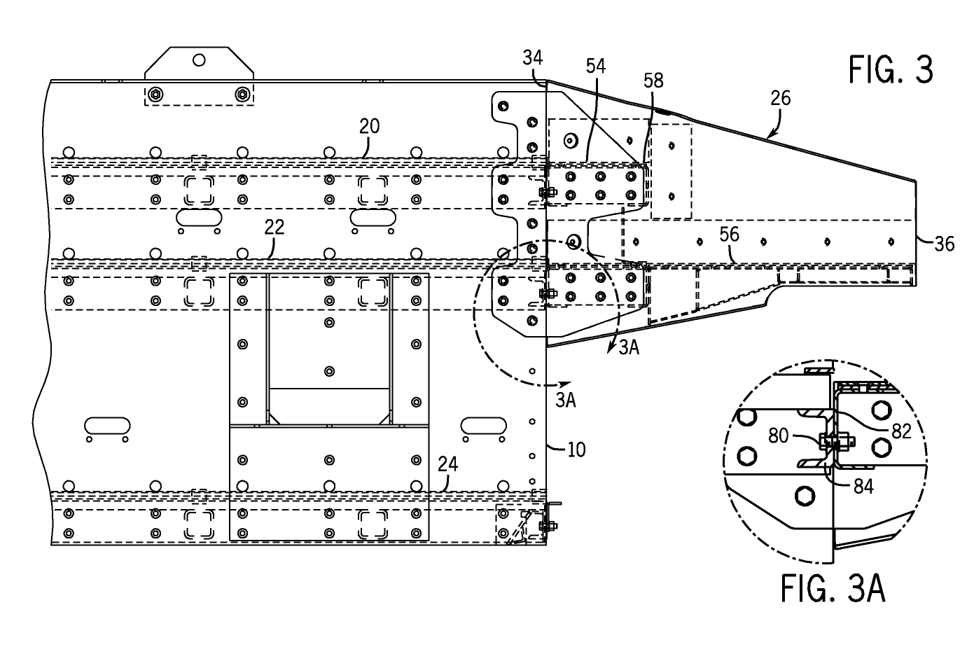

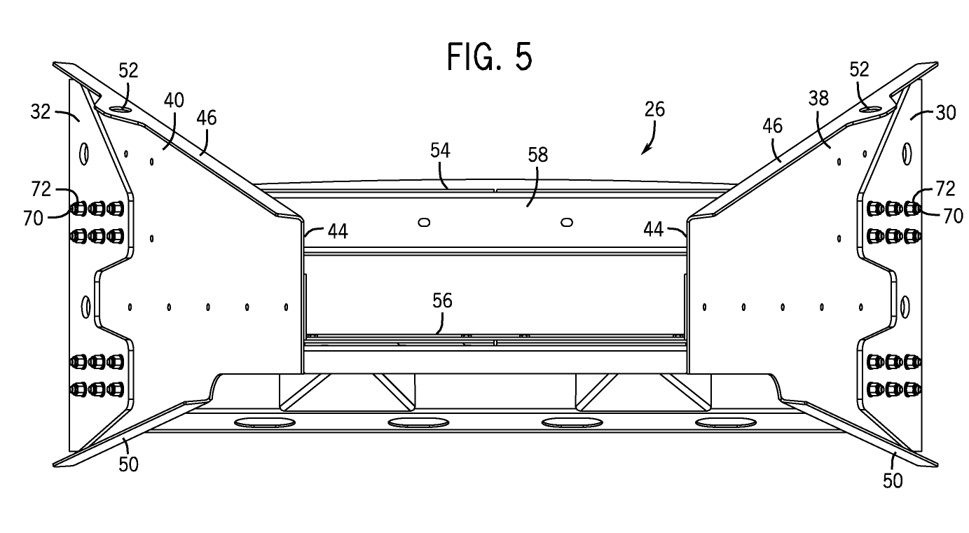

As can best be seen in FIG. 5, the upper base wall 54 is spaced vertically above the lower base wall 56. Thus, when the cone lip assembly 26 is attached to the vibrating screen unit 10, as shown in FIG. 1, the upper base wall 54 receives material from the top deck while the lower base wall 56 receives material from the middle deck of the vibrating screen unit. As illustrated in FIG. 3, the lower base wall 56 extends from the discharge end 36 to the infeed end 34 while the upper base wall 54 only extends from the infeed end 34 to an upper lip 58 that is spaced from the discharge end 36. Thus, the material from the top deck 20 is received on the upper base wall 54 and falls from the upper base wall 54 to the lower base wall 56 as the material passes over the upper lip 58.

Referring back to FIG. 4, the spaced side plates 38, 40 converge toward each other as they extend from the first end 42 to the second end 44. In the embodiment illustrated, the side plates 38, 40 converge toward each other at a constant rate from the first end 42 to the second end 44. The width of the infeed end 34 of the main body 28 shown in FIG. 4 is six feet while the width of the discharge end 36 is ______ feet. The size and dimensions are set forth for illustrative purposes only, since the cone lip assembly 26 could have various other configurations and sizes depending upon the vibrating screen unit and the cone crusher being used.

Referring back to FIGS. 1 and 2, the main body 28 of the cone lip assembly is mountable to the sidewalls 12, 14 of the vibrating screen unit 10 through the use of a pair of mounting brackets 30 and 32. The mounting brackets 30, 32 are each formed separately from the main body 28 and are securely attachable to and detachable from to both the side plates 38, 40 and the sidewalls 12, 14 of the vibrating screen unit.

FIG. 4 illustrates the mounting bracket 32 separated from the main body 28. The mounting bracket 30 shown attached to the main body 28 has the identical configuration to the mounting bracket 32. The mounting bracket 32 is formed from a single piece of sheet metal material and includes a lip mounting section 60 and a screen mounting section 62 that are joined to each other and angled along a center spine 64. The angle created by the center spine 64 compensates for the angle of the side plates 38, 40 relative to the planar sidewalls of the vibrating screen unit.

The lip mounting section 60 includes a series of mounting holes 66. When the mounting bracket 32 is positioned along the side plate 40, the mounting holes 66 align with a corresponding number of mounting holes 68 formed in the side plate 40. In the embodiment illustrated, a series of connectors 70 pass through the aligned mounting holes 66 and 68 and receive corresponding fasteners 72. The combination of the connectors 70 and fasteners 72 allow the mounting bracket 32 to be selectively connected to and disconnected from the side plate 40.

The screen mounting section 62 of the mounting bracket 32 also includes a series of mounting holes 74. The mounting holes 74 correspond in location and number to a series of mounting holes 76 formed in each of the first and second sidewalls 12, 14 of the vibrating screen unit 10, as illustrated in FIG. 2. As shown in FIG. 1, a series of connectors 78 are received in the aligned mounting holes to securely attach each of the mounting brackets 30 and 32 to the vibrating screen unit 10.

As illustrated in FIG. 2, the entire cone lip assembly 26 can be removed from the vibrating screen unit 10 by removing the connectors that attach the mounting brackets 30, 32 to the opposite first and second sidewalls 12, 14. In this condition, each of the side brackets 30, 32 remain securely attached to the cone lip assembly 26. After the side brackets 30, 32 have been disconnected from the sidewalls 12 and 14, the lifting eyes 52 can be used to lift and remove the cone lip assembly 26 for attachment and detachment from the vibrating screen unit 10.

Although not shown in FIGS. 1 and 2, the series of fasteners 72 can be removed from the corresponding connectors (not shown) such that the mounting brackets 30, 32 remain attached to the vibrating screen unit 10 and the main body 28 can be removed from the vibrating screen unit 10. Although not the preferred method of detachment, the mounting bracket 30, 32 can remain attached to the vibrating screen unit 10 when the cone lip main body 28 is removed.

In addition to the secure attachment of the pair of mounting brackets 30, 32, the cone lip assembly 26 is further secured to the vibrating screen unit 10 through a series of connectors 80 that passes through aligned holes in a stabilizing flange 82 formed as part of the cone lip assembly and a mounting bracket 84 formed as part of the vibrating screen unit. These connectors 80 provide additional stability for the cone lip assembly on the vibrating screen unit 10.

Although the embodiments shown in the drawing Figures include side plate 38, 40 that converge toward each other from the first end 42 to the second end 44 at a constant rate, it is contemplated that various other configurations for the side plate 38, 40 are within the scope of the present disclosure. As an example, the initial portion of the side plates 38, 40 extending from the first end 42 could extend parallel to the sidewalls of the vibrating screen unit and at some point transition to an angled condition to converge toward each other. Additionally, it is contemplated that the main body 28 of the cone lip assembly 26 could include only a single base wall, unlike the pair of spaced base walls 54, 56 shown in FIG. 4. In each of these embodiments, the main body 28 is formed separately from the pair of mounting brackets 30, 32 such that the entire cone lip assembly 26 can be more easily mounted and dismounted from the vibrating screen unit 10.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

I claim:

1. A cone lip for directing a supply of material from a vibrating screen unit to a crusher, comprising:
a main body having a pair of side plates attached to a base wall; and
a pair of mounting plates each formed separate from the main body, wherein each of the mounting plates is selectively attachable and detachable to one of the side plates and the vibrating screen unit.

2. The cone lip of claim 1 wherein each of the side plates extends from a first end to a second end, wherein the side plates converge toward each other from the first end to the second end.

3. The cone lip of claim 2 wherein the side plates are each planar from the first end to the second end such that the side plates converge toward each other at a constant rate.

4. The cone lip of claim 1 wherein the cone lip includes an upper base wall and a lower base wall that each extend between the pair of side plate, wherein the upper base wall and the lower base wall extend parallel to each other and are offset from each other.

5. The cone lip of claim 1 further comprising a pair of lifting eyes formed in the main body.

6. The cone lip of claim 1 wherein each of the mounting plates includes a plurality of screen mounting holes and a plurality of side plate mounting holes.

7. A system for feeding a supply of material to a crusher, the system comprising:
a vibrating screen unit having a pair of spaced sidewalls and a top deck; and
a cone lip assembly selectively attachable to and detachable from the vibrating screen unit to direct the supply of material from the vibrating screen unit to the crusher, the cone lip assembly comprising:
a main body having a pair of side plates each attached to a base wall; and
a pair of mounting plates each formed separate from the main body, wherein each of the mounting plates is selectively attachable and detachable to one of the side plate and one of the sidewalls of the vibrating screen unit to mount the cone lip assembly to the vibrating screen unit.

8. The system of claim 7 wherein each of the pair of mounting plates includes a plurality of screen mounting holes and a plurality of side plate mounting holes.

9. The system of claim 7 wherein each of the side plates extends from a first end to a second end, wherein the side plates converge toward each other from the first end to the second end.

10. The system of claim 9 wherein the side plates are each planar from the first end to the second end such that the side plates converge toward each other at a constant rate.

11. The system of claim 7 wherein the vibrating screen unit includes a middle deck positioned below the top deck, wherein the middle deck and the top deck each supply material to the crusher.

12. The system of claim 11 wherein the main body includes an upper base wall and a lower base wall that each extend between the pair of side plates, wherein the upper base wall receives material from the top deck and the lower base wall receives material from the middle deck when the cone lip assembly is attached to the vibrating screen unit.

13. The system of claim 7 further comprising a pair of lifting eyes formed on the main body.

14. A method of directing a supply of material from a vibrating screen unit to a crusher, the method comprising the steps of:
providing a cone lip having a main body including a pair of side plates attached to a base wall;
securely attaching a mounting plate to each of the pair of side plates; and
securely attaching the pair of mounting plates to opposite sidewalls of the vibrating screen unit.
